(19) United States
(12) Patent Application Publication
(10) Pub. No.: US 2012/0073854 A1
(43) Pub. Date: Mar. 29, 2012

(54) CONDUIT INNERDUCT HAVING REDUCED FRICTION AND HIGH STRENGTH

(76) Inventor: Jerry L. ALLEN, Centennial, WY (US)

(21) Appl. No.: 13/193,915

(22) Filed: Jul. 29, 2011

Related U.S. Application Data
(60) Provisional application No. 61/403,806, filed on Sep. 23, 2010.

(51) Int. Cl. H02G 3/04

(52) U.S. Cl. 174/68.1

(57) ABSTRACT

A device adapted to be for inserted into a conduit includes a first fabric material having a high tensile strength and a second fabric material having a low coefficient of friction. The materials are attached to each other to form an innerduct. A third fabric material of a low coefficient of friction may be attached to the first material to provide an innerduct whose outer surfaces present a low coefficient of friction. An innerduct or pull tape may also be formed by strands having an inner core of a high tensile strength and an outer sheath having a low coefficient of friction. The strands may be woven together to form the innerduct or pull tape.

### CROSS REFERENCE TO RELATED APPLICATION

This application claims priority from U.S. provisional patent application Ser. No. 61/403,806 filed on Sep. 23, 2010, which is incorporated herein by reference in its entirety.

### TECHNICAL FIELD

This invention relates to the construction of a fabric innerduct which is placed in an underground conduit and which is adapted to receive a cable or other item therein. This invention also relates to the construction of a fabric pull tape used to pull a cable into the conduit. More particularly, this invention relates to such an innerduct or pull tape which is made of a system of fabric that reduces the friction of its insertion into the conduit. Moreover, the system of fabric makes the insertion of a cable into the innerduct easier while increasing the tensile strength of the innerduct.

### BACKGROUND ART

Fabric innerducts, such as shown in U.S. Pat. No. 6,262,371, have been very successful in the communications industry. These innerducts are inserted into a conduit, which may extend for many miles underground, and they provide one or more compartments, or cells, into each of which a cable may be readily inserted. While such represents a significant improvement over their rigid innerduct predecessors, there is room for improvement in reducing the friction created when inserting the innerduct into the conduit and, in particular, when inserting a cable into a compartment of the innerduct.

These fabric innerducts must have the tensile strength to endure being pulled into a conduit, while at the same time provide as little frictional resistance as possible. To date these innerducts have been woven of a fabric material in such a way as to provide a compromise between high strength and low friction. Specifically, the fabric for these innerducts is typically woven with strands in the warp direction which are of a high tensile strength material and strands in the fill direction which are of a low friction material. Thus, some strength is lost, for the sake of low friction, and some friction is accepted for the sake of strength.

Pull tapes made of a fabric material and can be positioned in a compartment of an innerduct and thereafter utilized to pull a cable into the compartment. Like the innerduct, the pull tape must have the tensile strength required to pull the cable into the innerduct. However, prior art materials for such pull tapes have provided such tensile strength to the sacrifice of the ease of movement of the tape.

Thus, the need exists for an innerduct or pull tape which are made of a fabric which provides high tensile strength and at the same time low friction.

### DISCUSSION OF THE INVENTION

It is thus an object of one aspect of the present invention to provide a device to be introduced into a conduit, such as in the form of an innerduct or pull tape, which is made of two fabrics, one having a high tensile strength and the other having a low coefficient of friction.

It is an object of another aspect of the invention to provide a device, as above, whose outer surface is made of a material having a low coefficient of friction and which as an inner portion made of a material having high tensile strength.

These and other objects of the present invention, as well as the advantages thereof over existing prior art forms, which will become apparent from the description to follow, are accomplished by the improvements hereinafter described and claimed.

In general, a device to be inserted into a conduit includes a first material portion of a desired tensile strength and a second material portion having a desired coefficient of friction. The first and second material portions are positioned adjacent to each other.

In accordance with one particular aspect of the present invention, a device to be inserted into a conduit includes a first fabric material having a desired tensile strength and a second fabric material attached to the first fabric material and having a desired coefficient of friction.

According to another aspect of the present invention, a device to be inserted into a conduit includes a first fabric material having a desired coefficient of friction and a second fabric material attached to the first fabric material and having a desired tensile strength. A third fabric material is attached to the second fabric material and has a desired coefficient of friction.

In accordance with yet another aspect of the present invention, a device to be inserted into a conduit includes a plurality of strands of material. Each strand includes an inner core of a material having a desired tensile strength and another sheath of material around the core and having a desired coefficient of friction.

A preferred exemplary device in the form of an innerduct or pull tape according to the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a somewhat schematic, fragmented, side elevational view of an innerduct made in accordance with the present invention.

FIG. 2 is a sectional view taken substantially along line 2-2 of FIG. 1. FIG. 3 is an enlarged view of the portion of FIG. 2 encircled and labeled

FIG. 3. FIG. 4 is an enlarged view of the portion of FIG. 2 encircled and labeled

FIG. 4.

FIG. 5 is an enlarged partial sectional view taken substantively along line 5-5 of FIG. 2 and also represents a sectional view of a pull tape made in accordance with the present invention.

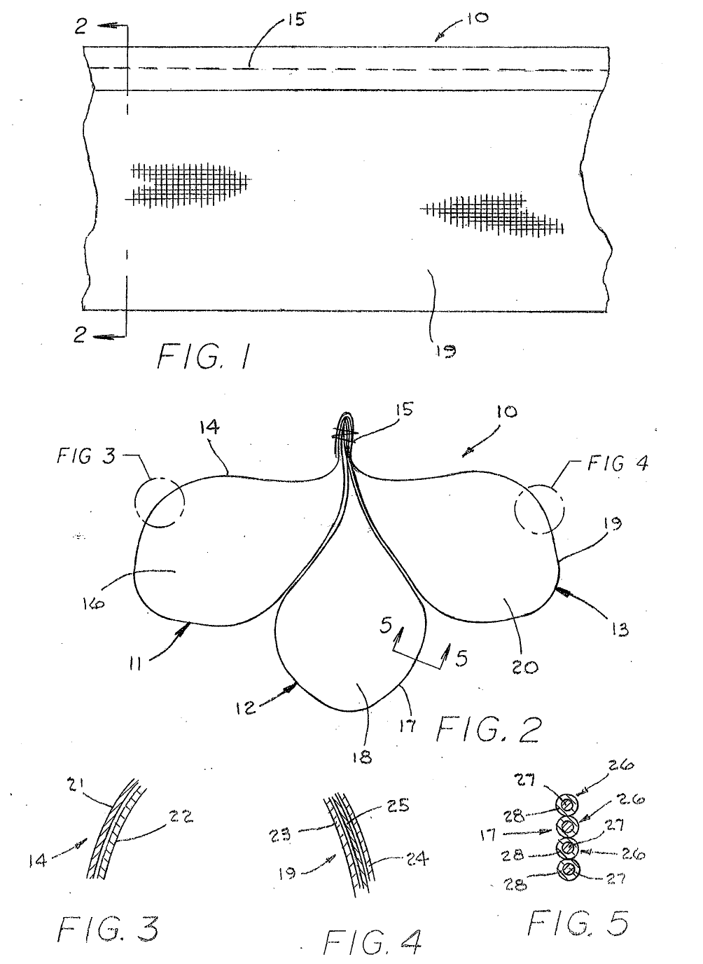

### PREFERRED EMBODIMENTS FOR CARRYING OUT THE INVENTION

An innerduct to be received in an underground conduct and made in accordance with the present invention is generally indicated by the numeral 10. Innerduct 10 is preferably made of a fabric material and can be of the type described in U.S. Pat. No. 6,262,371 to which reference is made for whatever details may be necessary for a full understanding of the present invention.

Innerduct 10 is shown as being made up of a plurality of cells, generally indicated by the numerals 11, 12 and 13. However, often times such innerducts may have only one cell or may have any number of a plurality of cells, three cells being shown herein. Cell 11 is made up of a fabric material 14 which is attached at its ends by a stitching 15 to form a compartment 16 for the receipt of a cable or similar item. Cell 12 is made up of a fabric material 17 which can be attached at its ends by the same stitching 15 that attached the ends of material 14 of cell 11. Thus, a compartment 18 is formed in cell 12 to receive a cable or similar item. Similarly, cell 13 is made up of a fabric material 19 which can be attached at its ends by stitching 15 so that cells 11, 12 and 13 are all attached to each other. A compartment 20 is formed in cell 13 to receive a cable or similar item.

As best seen in FIG. 3, the fabric material 14 of cell 11 is shown as being formed of two plies of fabric material, an outer ply 21 being of a high tensile strength material and an inner ply 22 being of a material having coefficient of a low friction. As used herein, a high tensile strength material is one having a tensile strength from approximately 230 pounds per inch or greater and a material having a low coefficient of friction is one having a coefficient of friction from about 0.10 to about 0.15. As a result, ply 21 gives cell 11 a surface with strength, while ply 22 allows a cable or other item to be easily inserted therein by providing a surface with a desired coefficient of friction. Plies 21 and 22 may be attached to each other by any suitable means such as sewing, heat bading, or by an adhesive. While the other cells of innerduct 10 could all be of the two ply concept of cell 11, for purposes of this description, the other two cells, 12 and 13, are shown as being differently constructed.

For example, as best seen in FIG. 4, the fabric material 19 of cell 13 is shown as being formed of three plies of fabric material. The inner ply 23 and the outer ply 24 are a material made of a low coefficient friction material, while a central ply 25, which is sandwiched between plies 23 and 24, is made of a material having a desired high tensile strength. As a result, ply 25 gives cell 13 strength, ply 23 presents a surface and allows a cable or other item to be easily inserted in cell 13, and ply 24 presents a surface which makes it easier to insert cell 13 into a conduit. Plies 23, 24 and 25 may be attached to each other in the same manner as plies 21 and 22. As previously indicated, although cell 13 is being described as having the three plies 23, 24 and 25, cells 11 and 12 could be likewise constructed.

As best shown in FIG. 5, the fabric material 17 of cell 12 or of a pull tape can be made of strands 26 of material 17 are co-extruded of two different materials and woven to form cell 12 or the pull tape. That is, each strand 26 of material 17 has an inner core 27 made of a material having a desired high tensile strength and an outer sheath 28 made of a material having a desired low coefficient of friction. Thus, the outer surface of both sides of material 17, when woven, provides low friction to accomplish both ease of insertion into a conduit and ease of insertion of a cable or other item into cell 12. At the same time, core 27 provides the necessary strength for cell 12. As previously indicated, although cell 12 is being described as being woven from these unique strands 26, cells 11 and 13 could be likewise so constructed.

What is claimed is:

1. A device to be inserted into a conduit comprising a first material portion of a desired tensile strength, and a second material portion having a desired coefficient of friction, said first and second materials being positioned adjacent to each other.

2. The device of claim 1, said first and second materials being attached to each other.

3. The device of claim 2 wherein said first and second material portions are fabrics.

4. The device of claim 3 wherein said first material portion defines one surface of the device and said second material portion defines an opposed surface of the device.

5. The device of claim 4 wherein said first and second material portions form an innerduct adapted to be inserted into a conduit.

6. The device of claim 1 further comprising a third material portion having a desired low coefficient of friction, said second material portion being attached to said first material portion, and said third material portion being attached to said first material portion.

7. The device of claim 6 wherein said first, second and third material portions are fabrics.

8. The device of claim 7 wherein said second material portion defines one surface of the device and said third material portion defines an opposed surface of the device.

9. The device of claim 8 wherein said first, second and third material portions form an innerduct adapted to be inserted into a conduit.

10. The device of claim 2 wherein said first and second material portions form a strand when attached to each other.

11. The device of claim 10 wherein said second material portion forms the outside of said strand.

12. The device of claim 11 wherein a plurality of said strands are woven together to form an innerduct and adapted to be inserted into a conduit.

13. The device of claim 11 wherein a plurality of said strands are woven together to form a pull tape adapted to be inserted into a conduit.

14. A device to be inserted into a conduit comprising a first fabric material having a desired tensile strength, and a second fabric material attached to said first fabric material and having a desired coefficient of friction.

15. A device to be inserted into a conduit comprising a first fabric material having a desired coefficient of friction, a second fabric material attached to said first fabric material and having a desired tensile strength, and a third fabric material attached to said second fabric material and having a desired coefficient of friction.

16. A device to be inserted into a conduit comprising a plurality of strands of material, each said strand including an inner core of a material having a desired tensile strength and an outer sheath of material around said core and having a desired coefficient of friction.

17. A device according to claim 16 wherein said strands are woven together to form an innerduct.

18. A device according to claim 16 wherein said strands are woven together to form a pull tape.
